(19) United States
(12) Patent Application Publication
(10) Pub. No.: US 2007/0148301 A1
(43) Pub. Date: Jun. 28, 2007

(54) DOUGH FORMING PROCESS

(76) Inventors: James W. Finkowski, Andover, MN (US); Thomas P. Kempf, Plymouth, MN (US); Michael D. Engesser, Coon Rapids, MN (US); Dennis B. Usgaard, Crystal, MN (US)

Correspondence Address: GENERAL MILLS, INC., P.O. BOX 1113, MINNEAPOLIS, MN, 55440, US

(21) Appl. No.: 11/613,537

(22) Filed: Dec. 20, 2006

Related U.S. Application Data
(60) Provisional application No. 60/754,081, filed on Dec. 27, 2005.

(51) Int. Cl. A21D 10/00

(52) U.S. Cl. 426/549

(57) ABSTRACT

Methods and apparatus for forming preportioned dough units utilizing a forming grid having at least one non-round formation apertures allowing a sheet of dough to be cut so as to substantially eliminate dough waste while providing generally equivalent dough unit portion sizes. The forming grid include one or more formation portions extending from a formation surface. Each formation portion can include an access aperture allowing an ejection member to be slidably inserted through a formation throughbore whereby a proportioned dough unit is ejected from the forming grid. The forming grid can include a peripheral retainer ring to constrain dough as the dough units are formed. The forming grid can be used to cut a dough sheet that has been previously extruded or placed within a packaging tray. Ultrasonic energy can be utilized with the forming grid to further promote cutting and dough release.

### PRIORITY CLAIM

The present application claims priority to U.S. Provisional Application Ser. No. 60/754,081, filed Dec. 27, 2005, and entitled “DOUGH FORMING PROCESS”, which is herein incorporated by reference in its entirety.

### FIELD OF THE INVENTION

The invention relates generally to forming dough units. More specifically, the invention is directed to a process for forming round-like dough units from a dough sheet.

### BACKGROUND OF THE INVENTION

Due to the demands and stresses of modern life, many people no longer have the time or desire to create meals or desserts from scratch. Instead, people often purchase ready-to-eat products that are prepared for immediate consumption without further preparation or ready-to-bake products that are prepared so as to go directly from the pantry, refrigerator or freezer to the oven or other associated baking appliance. In addition, commercial bakers frequently make use of ready-to-bake products to save time when preparing the large quantities of baked goods they often prepare on a daily basis.

One ready-to-bake dough product that continues to gain in popularity is ready-to-bake cookies, for example cookies sold by the Pillsbury division of General Mills, Inc., which can go from a refrigerated or frozen dough state to a freshly prepared, hot cookie in a matter of minutes. The only preparation steps required are to heat the oven, remove the dough unit from the packaging, place the dough unit on a cooking sheet and place the cooking sheet within the oven. Not only can fresh cookies be prepared in just a few minutes, the individual or commercial baker can be assured that the taste and general appearance will be of a consistent quality without any concern for possible errors from preparation of the dough from scratch.

One representative manner in which ready-to-bake dough units are formed is to extrude a large sheet of dough, which is then cut or scored to form square dough products. Typically, cutting instruments such as, for example, a cutting wire, a rotary cutting instrument or a blade is used to cut or score the sheet of dough. While this cutting process can be accomplished quickly and efficiently, certain disadvantages are inherent with these cutting operations. For example, individual dough units may not be consistently portioned such that there can be significant size deviations from one unit to the next. Particulates added to a visible major surface, i.e., a top surface, may be pushed into the dough where they are no longer visible. In addition, it may be difficult to separate individual dough units from the sheet.

While the current methods for forming ready-to-bake dough units from a dough sheet can provide for tasty baked dough products, it would be advantageous to prepare the ready-to-bake dough units in a manner that provides consistently portioned dough units while providing that particulates added to a visible major surface remain visible following formation of the dough units.

### SUMMARY OF THE INVENTION

The invention addresses the aforementioned needs by providing for methods and apparatus for forming preportioned dough units in a substantially round shape utilizing a forming grid. Through the use of a forming grid having one or more non-round apertures, a sheet of dough can be cut so as to minimize dough waste while providing generally equivalent portion sizes. In addition, the use of the forming grid helps to direct any added particulates such that they are presented on a visible major surface of the dough units. The forming grid can be used with a variety of dough types such as, for example, cookie dough and non-flowable batter products such as muffin and cake batter as disclosed and described in U.S. patent application Ser. Nos. 11/462,179 and 11/462,214 and PCT Application Serial No. PCTUS2006/030309, each being commonly assigned to the assignee of the present application and being herein incorporated by reference to the extent not inconsistent with the present application.

In one aspect, a forming grid generally comprises one or more formation portions extending from a formation surface. The formation portions generally comprise a non-circular formation aperture, a transition portion and an intermediate portion. The formation portions can further include an access aperture for defining a formation throughbore. The non-circular formation aperture is located proximate the formation surface and can have a non-circular opening such as, for example, a square, rectangle, octagon, triangle and or other suitable geometries. The transition portion can generally comprise an angled, curved and/or tapered cross-section within the formation throughbores and operably interconnecting the non-circular formation aperture and the intermediate portion. The intermediate portion can comprise a generally round cross-section. The access aperture can comprise any suitable opening such as, for example, round, generally round and similar openings for providing access to the interior of the formation throughbores. In some embodiments, the forming grid can include a perimeter retainer ring so as to constrain a dough being formed within the boundary of the forming grid. In some embodiments, the forming grid can comprise expanding formers to assist in positioning dough units such as, for example, moving dough units to a packaging center line. The forming grid can further comprise an assembly of multiple forming arrays to form the forming grid wherein the number of forming arrays can be varied based upon desired production rates and/or dough sheet size. In some embodiments, the forming grid can utilized ultrasonic energy and can comprise a plurality of ganged ultrasonic transducers, wherein each transducer defines and individual forming portion.

In another aspect, a method for forming dough units can comprise pressing a forming grid into a dough sheet wherein the forming grid comprises at least one non-circular aperture so as to substantially eliminate dough waste and/or the need for dough recycling/recovery. In some embodiments, the dough sheet can already be positioned within a packaging tray or on a packaging sheet as the dough units are formed. The method can further comprise retaining an external perimeter of the dough sheet as the dough units are formed. The method can further comprise placing edible particulates on an upwardly facing surface of the dough sheet prior to pressing the cookie dough sheet with the forming grid such that the particulates are funneled into and through the non-circular aperture and are positioned on an upwardly facing surface of the dough unit. The method can further comprise ejecting the dough units from the forming grid through insertion of an ejection member through an access aperture so as to press on the upwardly facing surface and eject the dough units from the non-circular aperture. The method can further comprise application of ultrasonic energy to promote cutting and/or release of the dough units from the forming grid.

In another aspect, a method for visibly presenting edible particulates on a visible surface of a dough unit by funneling the edible particulates to the visible surface while substantially eliminating damage to the edible particulates or pressing of the edible particulates into a dough sheet. Representative edible particulates can comprise, for example, chocolate chips, nuts, candy and the like or placement on cookie dough units or alternatively, meat bits, vegetables, cheese, spices and the like for placement on dough units.

In another aspect, a method for individually separating a plurality of dough units can comprise providing an access space between adjacent dough units proximate an upwardly facing surface of the dough units that has a substantially increased cross-sectional area when compared to a cross-sectional area proximate a downwardly facing, joined surface between adjacent cookie dough units.

In another aspect, a method for providing a plurality of substantially round dough units can comprise pressing a sheet of dough with a forming grid having non-round forming apertures such that adjacent dough units are detachably connected at a downward facing surface of the dough units. The plurality of dough units can be formed utilizing a single forming grid or a plurality of ganged forming grids depending upon variable such as dough sheet size and desired rates of production of dough units.

In another aspect, a method for providing a plurality of individual dough units can comprise positioning and/or extruding a dough sheet into a packaging tray. A forming grid having a plurality of non-circular formation apertures can be used to cut the dough sheet within the packaging tray such that a plurality of individually formed dough units are formed within intermediate portions of the forming grid.

In another aspect, a system for providing a substantially round dough unit from a dough sheet can comprise a forming grid and a dough retention member. The forming grid can include a plurality of formation portions. The dough retention member can be positioned over the dough sheet to retain the dough sheet as the dough units are formed.

The above summary of the various aspects of the disclosure is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a plan view of an access surface of a representative embodiment of a forming grid.

FIG. 2 is a perspective view of a forming surface of the forming grid of FIG. 1.

FIG. 2a a partial perspective view of the forming surface of FIG. 2.

FIG. 3 is a perspective view of a representative embodiment of an ejection member of the present invention.

FIG. 3a is a side view of the ejection member of FIG. 3.

FIG. 3b is an end view of the ejection member of FIG. 3.

FIG. 4 is a perspective view of the forming grid of FIG. 1 positioned proximate a sheet of cookie dough.

FIG. 5 is a perspective view of the forming grid of FIG. 1 pressed into the sheet of cookie dough for forming cookie dough units.

FIG. 6 is a perspective view of the forming surface of the forming grid of FIG. 1 following pressing of the forming grid into the sheet of cookie dough.

FIG. 7 is a perspective view of the ejection member of FIG. 3 positioned to interface with the access surface of the forming grid of FIG. 1.

FIG. 8 is a perspective view of a dough unit set ejected from the forming grid of FIG. 1.

FIG. 9 is a perspective view of the dough unit set including a plurality of individually separated cookie dough units.

FIG. 10 is a perspective view of an embodiment of a forming grid assembly.

FIG. 11 is a side view of the forming grid assembly of FIG. 10.

FIG. 12 is an end view of an embodiment of an ultrasonic forming grid assembly.

FIG. 13 is a perspective view of an embodiment of an ultrasonic transducer.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE EMBODIMENTS

Exemplary aspects of the present invention are further disclosed and described in the following numbered paragraphs.

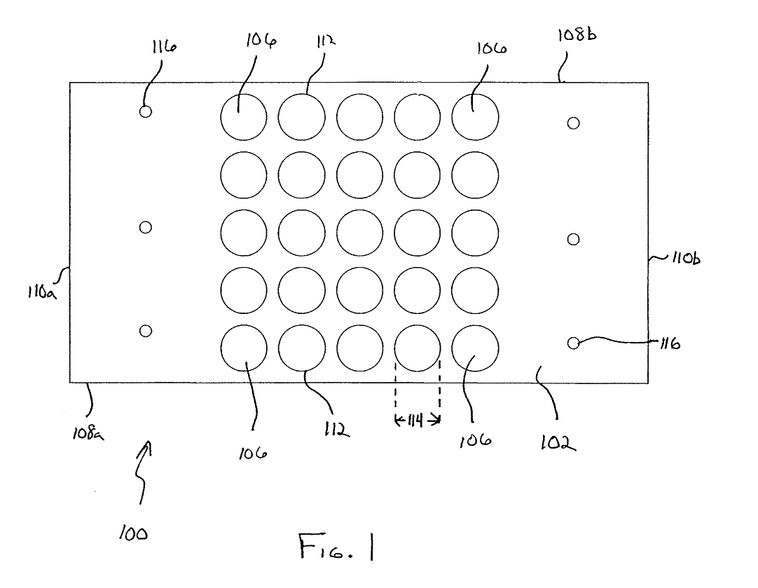

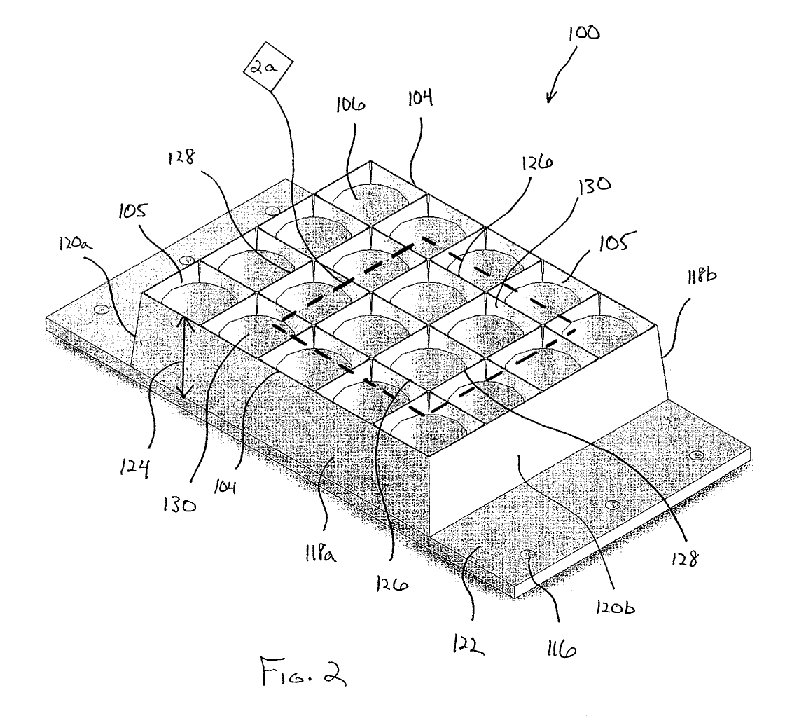

Referring now to FIGS. 1, 2 and 2a, a forming grid 100 generally comprises an access surface 102, a formation surface 104 and at least one dough forming portion 105. Forming grid 100 can comprise suitable materials for use with food processing such as, for example, stainless steel. Access surface 102 and formation surface 104 can be operably interconnected such that each dough forming portion 105 is defined by a formation throughbore 106. Forming grid 100 can be fabricated so as to comprise any suitable number of dough forming portions 105 based on processing conditions such as, for example, a desired rate of manufacturing and physical size constraints for a processing line. In one representative embodiment, forming grid 100 can comprise four rows of dough forming portions 105 wherein each row comprises five formation portions 105 for a total of twenty formation portions 105 as depicted in FIGS. 1 and 2.

As illustrated in FIG. 1, access surface 102 generally comprises a pair of first opposed sides 108a, 108b and a pair of second opposed sides 110a, 110b. Each of the formation throughbores 106 have an access aperture 112 having an access diameter 114. Access surface 102 can further comprise one or more attachment bores 116 providing for detachable connection of the forming grid 100 to processing equipment such as, for example, a stamping machine.

As illustrated in FIG. 2, formation surface 104 is generally defined by a first pair of projecting walls 118a, 118b and a second pair of projecting walls 120a, 120b. The first pair of projecting walls 118a, 118b and the second pair of projection walls 120a, 120b can be arranged in a generally perpinucular orientation to an underside 122 of the access surface 102. Alternatively, the first pair of projecting walls 118a, 118b and the second pair of projecting walls 120a, 120b may be in an angled orientation of the underside 122. The first pair of projecting walls 118a, 118b and the second pair of projecting walls 120a, 120b are defined by a wall height 124 projecting outwardly from underside 122. Depending upon the desired number of formation potions 105, formation surface 104 can be further defined by one or more first interior walls 126 arranged generally parallel to the first pair of projecting walls 118a, 118b as well as one or more second interior walls 128 can be arranged generally parallel to the second pair of projecting walls 120a, 120b. Through the combination of the first pair of projecting walls 118a, 118b, the second pair of projecting walls 120a, 120b, the first interior walls 126 and the second interior walls 128, a formation aperture 130 is defined for each formation throughbore 106.

Formation aperture 130 can comprise a generally non-circular opening such as, for example, a rectangle or square, as shown in FIGS. 2 and 2a, as well other suitable geometric shapes such as, for example, hexagonal and the like.

As illustrated in FIG. 2a, each formation portion 105 is generally defined by the formation aperture 130, a transition portion 132 and an intermediate portion 134. When formation portion 105 is defined by a formation throughbore 106, the formation portion 105 further includes access aperture 112. Formation aperture 130 defines a formation cross-sectional area 136 exceeding an intermediate cross-sectional area 138 defined by the intermediate portion 134. In some representative embodiments, formation cross-sectional area 136 can generally range in size from about 0.5 square inches to about 9 square inches depending on factors such as baking characteristics for a dough, for example, bake expansion, as well as finished baked properties such as final size including cross-sectional area and thickness. In one presently preferred embodiment, intermediate cross-sectional area 138 can comprise a circular or round-like cross-sectional area and corresponds to the shape and size of access aperture 112. Transition portion 132 generally comprises a plurality of transition surfaces 140 defined between the formation surface 104 and an intermediate junction 142 so as to smoothly transition from the larger formation cross-sectional area 136 to the smaller intermediate cross-sectional area 138. Transition surfaces 140 can comprise suitable configurations such as, for example, tapered, curved and/or angled surfaces. Each formation throughbore 106 comprises a formation length 144 generally comprised of a transition length 146 and an intermediate length 148.

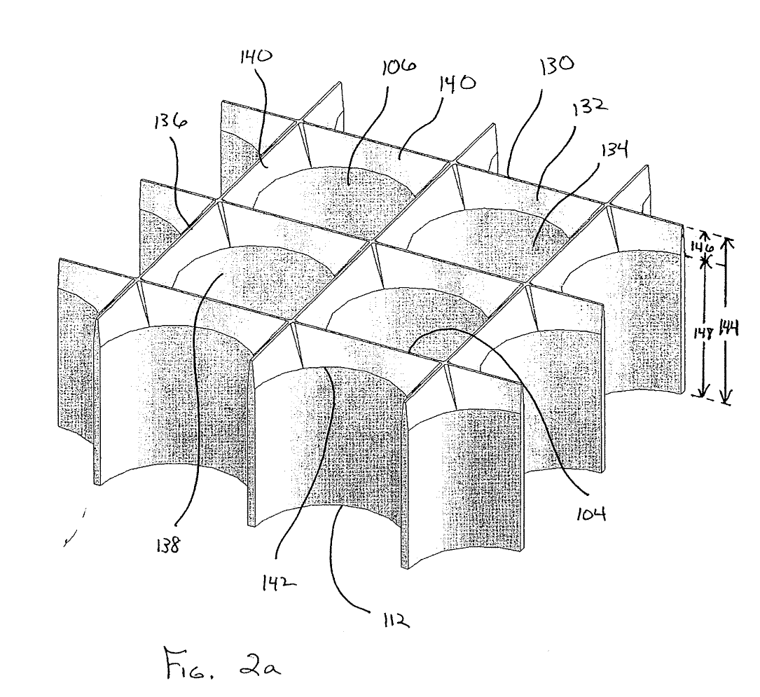

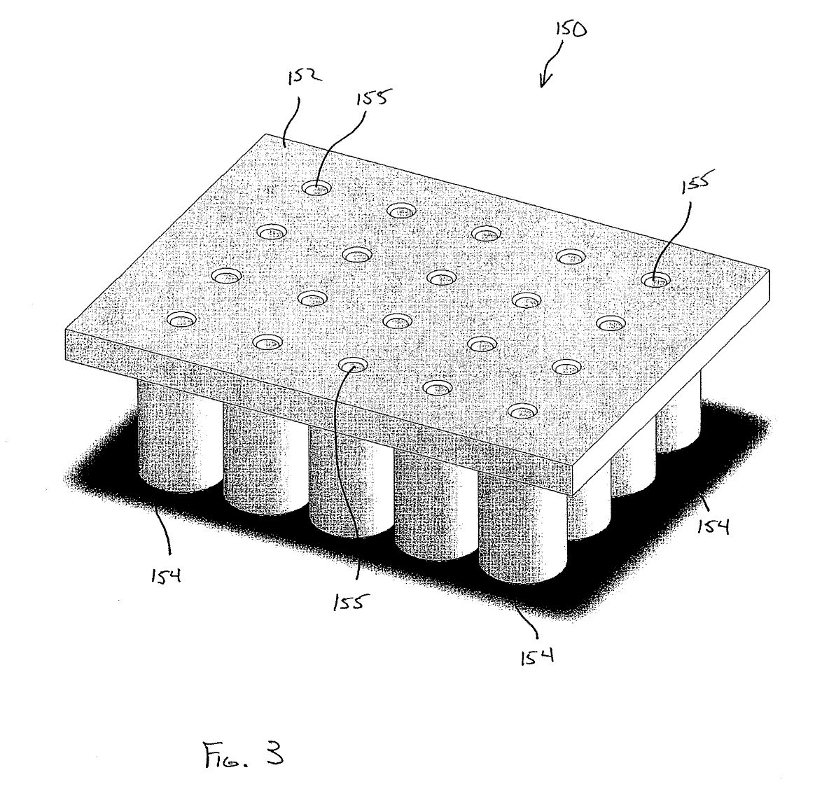

As illustrated in FIGS. 3, 3a and 3b, an ejection member 150 generally comprises a base member 152 and one or more plungers 154. Ejection member 150 can comprise suitable materials of construction for use with food processing such as, for example, stainless steel, coated aluminum, suitable plastics and can comprise the same materials as forming grid 100. Plungers 154 can be formed integrally to the base member 152 or can be attached with a suitable connector such as, for example, a threaded post or connector attaching to a connector throughbore 155 in the base member 152. Each plunger 154 has an ejection cross-sectional area 153 that is slightly less in size but similarly shaped to the access aperture 112 and intermediate cross-sectional area 138. Plunger 154 has a plunger length 156 that is greater than formation length 144.

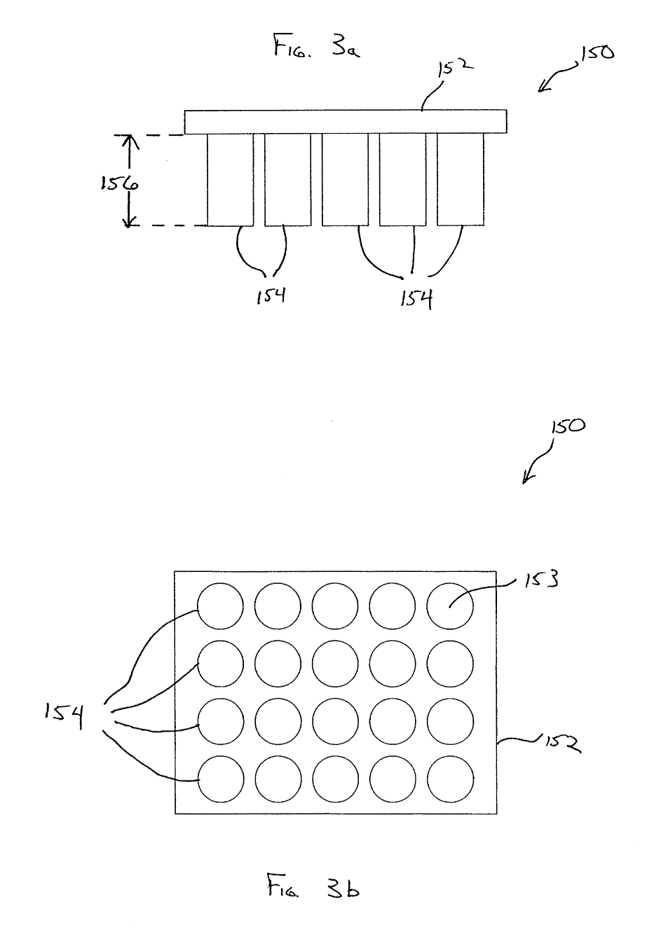

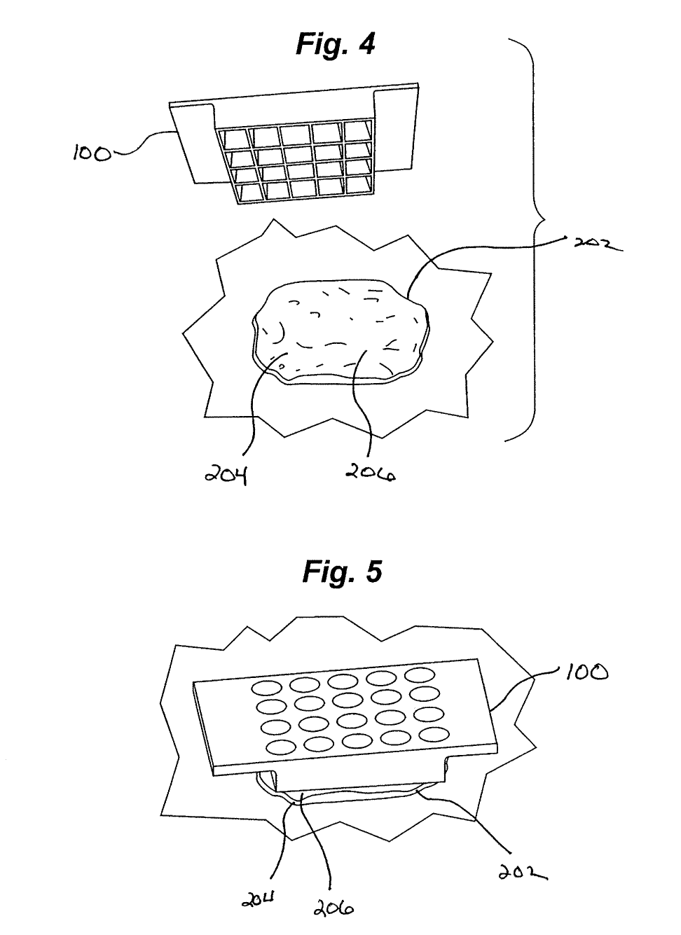

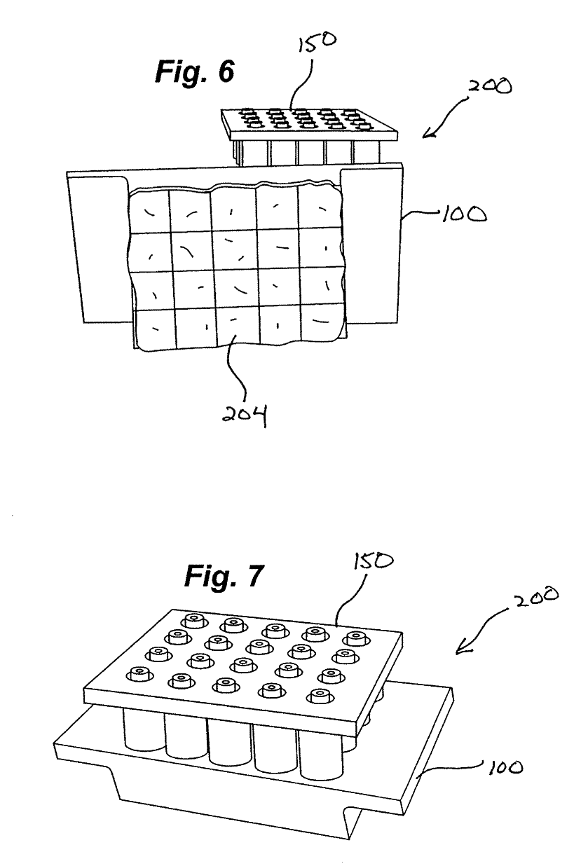

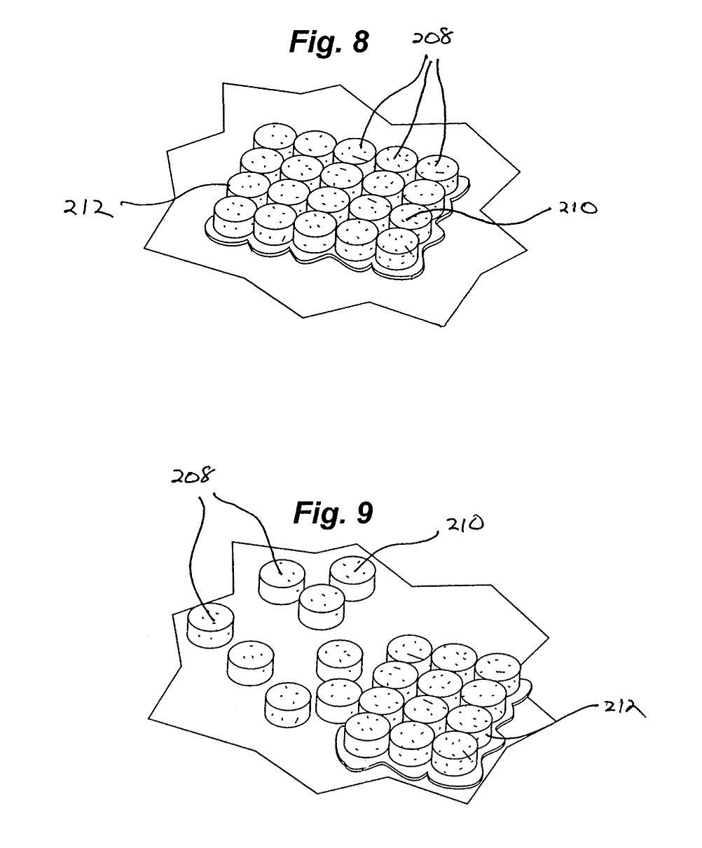

Use of a dough unit formation system 200 is illustrated in FIGS. 4, 5, 6, 7, 8 and 9. As described with reference to FIGS. 4-9, use of dough unit formation system 200 is illustrated and described with reference to a cookie dough though it will be understood that the dough unit formation system 200 can be used with additional dough types including non-flowable batter products. In a most basic form, dough unit formation system 200 comprises forming grid 100 and ejection member 150. In alternative arrangements, dough unit formation system 200 can comprise additional components for automating a formation process. For example, dough unit formation system 200 can comprise automated components such as, for example, an extruder, a conveyor, a stamping apparatus, a freezing tunnel, a packaging system and the like so as to allow for high volume production of dough units.

As illustrated in FIG. 4, a first step in preparing cookie units is formation of a generally flat sheet 202 of cookie dough 204. Cookie dough 204 can comprise any of a variety of cookie dough such as, for example, sugar cookie dough, oatmeal cookie dough, chocolate chip cookie dough or peanut butter dough. Flat sheet 202 can be formed by hand rolling cookie dough 204 for small batches of cookie or alternatively, cookie dough 204 can be extruded utilizing a conventional extruder, for example extruders of the type currently manufactured and sold by APV Baker of Peterborough, United Kingdom, or Bepex GMBH of Leingarten, Germany. Depending upon the type of cookie unit being prepared, edible particulates such as, for example, chocolate chips, candies, nuts and the like, can be placed on an upwardly facing surface 206 of the flat sheet 202. When dough unit formation system 200 is utilized with alternative dough types, suitable edible particulates can include, for example, meat bits, vegetables, spices, cheese and the like. In addition, a dough release agent such as, for example, flour or a vegetable oil can be sprinkled or sprayed on the upwardly facing surface 206.

Once flat sheet 202 has been formed, forming grid 100 is positioned such that formation surface 104 is positioned proximate the upwardly facing surface 206. Forming grid 100 is pressed into flat sheet 202 such that formation surface 104 traverses the thickness of flat sheet 202. As forming grid 100 is pressed through the flat sheet 202, individual cookie dough units 208 are formed within each formation portion 105. As the formation aperture 130 is generally square, all of the cookie dough 204 bounded by the first pair of projecting walls 118a, 118b and the second pair of projecting walls 120a, 120b is captured and directed into the formation portions 105. As the formation surface 104 is pressed through flat sheet 202, cookie dough 204 initially assumes the shape of formation cross-sectional area 136. As the formation surface 104 is directed further downward, cookie dough 204 is funneled though the transition portion 130 wherein the transition surfaces 140 transition the cookie dough 204 to assume the shape of intermediate cross-sectional area 138. Any edible particulates and/or dough release agent on upwardly facing surface 206 is funneled and stacked/positioned or cut-through on an upper unit surface 210. When formation surface 104 has passed entirely through the flat sheet 202, cookie dough 204 completely fills the formation portion 105 such that the shape of cookie dough unit 208 substantially resembles the interior of formation portion 105 and such that the individual cookie dough units 208 comprise fully separated units.

Following insertion of the forming grid 100 into flat sheet 202 to define the cookie dough units 208, ejection member 150 is positioned such that the plungers 154 are proximate the access apertures 112. Plungers 154 are pressed into the access apertures 112 wherein the plunger contacts the upper unit surface 210. Ejection member 150 is pressed toward the forming grid 100 such that the base member 152 slidingly abuts the access surface 102 wherein plunger 154 passes through the formation throughbore 106 and reaches the formation surface 104. When plunger 154 reaches the formation surface 104, a dough unit block 212 is separated from the forming grid 100. In the event that the upwardly facing surface 206 includes a dough release agent, the dough release agent prevents sticking between the plunger 154 and the cookie dough unit 208. Dough unit block 212 generally comprises the individually, separated cookie dough units 208.

Through the use of dough unit formation system 200, each cookie dough unit 208 is pre-portioned and configured to have the same size, shape and volume. As forming grid 102 captures all of cookie dough 204 bounded by the forming grid 102, none of the cookie dough 204 is wasted and the packaging cross-sectional area required for packaging dough unit block 212 is substantially the same size as required for flat sheet 202. In addition, the funneling action of the transition portion 132 causes any edible particulates to be prominent displayed on the upwardly facing surface 206 resulting in a visually appealing appearance and preventing waste of the edible particulates.

Through the use of dough unit formation system 200 with an automated process system, further process efficiencies can be achieved. For example, forming grid 100 can be quickly detached from the automated processing equipment through the use of attachment bores 116. Detachable connection of the forming grid 100 provides benefits such as, for example, an ability to quickly change the size and shape of cookie dough unit 208 through adjustment of the size and shape of the formation portions 105 as well as allowing for efficient cleaning and maintenance of the forming grid 100. In addition, a plurality of dough unit formation systems 200 can be ganged together and simultaneously used based on desired production requirements and/or dough sheet sizes. In some representative embodiments, forming grid 100 can be sized and configured so as to correspond to a packaging assembly such as, for example, a packaging tray allowing the cookie dough units to be quickly packaged for shipment, storage and use. In addition, dough unit formation system 200 can comprise additional features such as, for example, expanding elements allowing the cookie dough units 208 to be positioned and matched relative to packaging multiple packing trays simultaneously or the inclusion of individually controllable plungers 154 for packaging purposes.

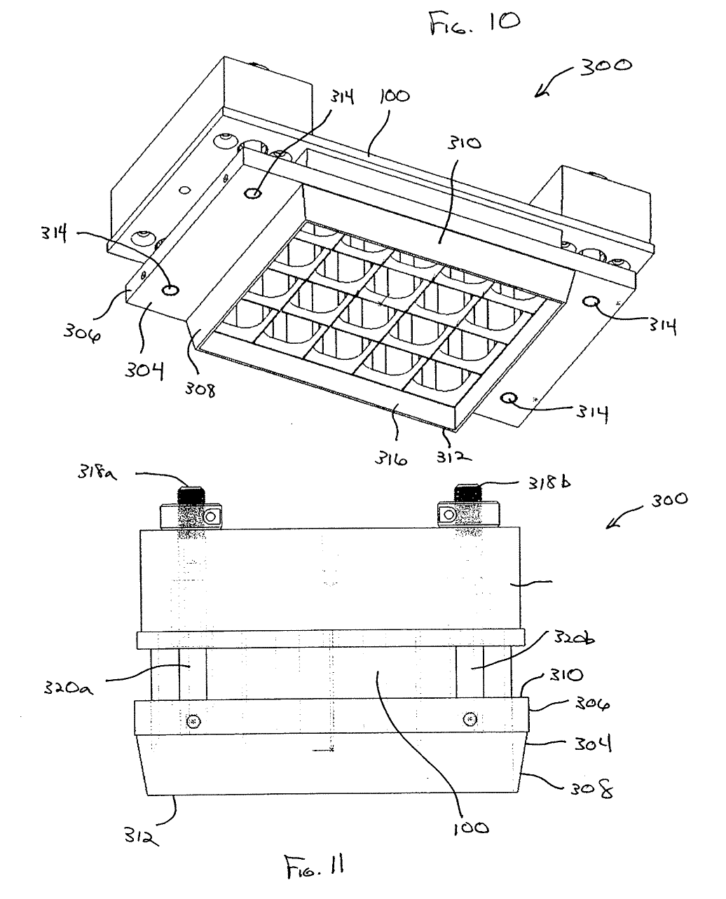

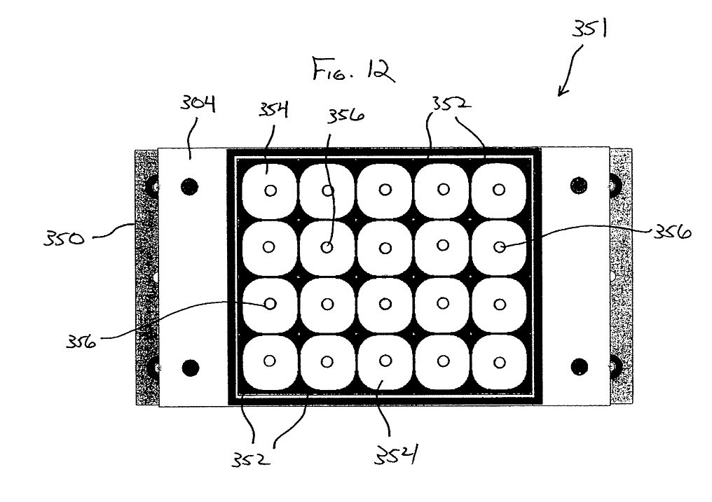

In another representative embodiment, a forming grid assembly 300 can comprise an embodiment of a forming grid such as, for example, forming grid 100 and a dough retention member 304 as illustrated in FIGS. 10 and 11. Dough retention member 304 can comprise a coupling portion 306 and a retention portion 308. Coupling portion defines a top surface 310 while retention portion 308 comprises a peripheral retention wall 310 and a bottom surface 312. Top surface 310 generally includes a plurality of coupling bores 314. A receiving aperture 316 is operably defined in the dough retention member 304 so as to continually extend between the top surface 310 and the bottom surface 312. The receiving aperture 316 is configured so as to be similarly shaped and slightly larger than the forming grid 100 such that the forming grid 100 is slidably insertable into the receiving aperture 316.

As illustrated in FIGS. 10 and 11, a pair of coupling members 318a, 318b can be utilized to operably join the forming grid 100 and dough retention member 304 so as to define the forming grid assembly 300. Coupling members 318a, 318b provide a sliding portion 320a, 320b allowing the forming grid 100 to be slidably positionable with respect to the dough retention member 304.

In use, forming grid assembly 300 can be used as part of dough unit formation system 200 to form individual cookie dough units 208 that are substantially similar in look and appearance as those formed with forming grid 100. Forming grid assembly 300 can be quickly attached/detached from automated processing equipment through the use of attachment bores 116 as previously described with respect to the forming grid 100. By providing for detachable connection of the forming grid assembly 300, benefits including the ability to quickly change the size and shape of cookie dough unit 208 through adjustment of the size and shape of the formation throughbores 106 as well as allowing for efficient cleaning and maintenance of the forming grid 100 and dough retention member 304. In addition, the further inclusion of dough retention member 304 provides the additional benefit of preventing dough migration beyond the boundary of the forming gird 100, which can be especially beneficial when the flat sheet 202 is extruded or placed directly within a packaging tray prior to cutting with the forming grid assembly 300.

In one presently preferred embodiment, dough present as flat sheet 202 is placed or extruded directly into a packaging tray or sheet. Preferably, the packaging tray has a shape resembling but slightly larger than the dough retention member 304. The packaging tray can comprise a flat sheet of packaging material or can comprise a walled container. Once flat sheet 202 is positioned with respect to the packaging tray, forming grid assembly 300 is positioned such that bottom surface 312 is positioned proximate the upwardly facing surface 206 of flat sheet 202. The forming grid assembly 300 is then directed downward such that the bottom surface 312 contacts the packaging tray and peripheral retention wall 310 encloses the flat sheet 202. Preferably, flat sheet 202 is slightly smaller than receiving aperture 316 such that the bottom surface 312 does not cut through the flat sheet 202 as it is directed downward. At this point, flat sheet 202 should be fully contained within the dough retention member 304.

Once bottom surface 312 is in contact with the packaging tray and flat sheet 202 is contained within the dough retention member 304, downward pressure is applied to forming grid 100 causing it to be directed downward through the receiving aperture 312. This can be accomplished by applying downward force with the automated processing equipment with the position of dough retention member 304 being fixed by contact of the bottom surface 312 with the packaging tray. As forming grid 100 is directed downward through the receiving aperture 312, forming grid 100 is pressed through the flat sheet 202 and individual cookie dough units 208 are formed within each formation portion 105 in a similar manner as previously described.

Once forming gird 100 has been inserted through the flat sheet 202 to define the cookie dough units 208, the biasing members 320a, 320b can direct the forming grid 100 in an upward direction such that forming grid 100 is positioned above the packaging tray while bottom surface 312 remains in contact with the packaging tray. At this point, the cookie dough units 208 can be removed from the formation portions 105 and positioned on the packaging tray while the dough retention member 304 physically keeps the cookie dough units 208 within the boundary of the packaging tray. In one embodiment, ejection member 150 is utilized as previously described to physically eject the cookie dough units from the forming grid assembly 300 and onto the packaging tray.

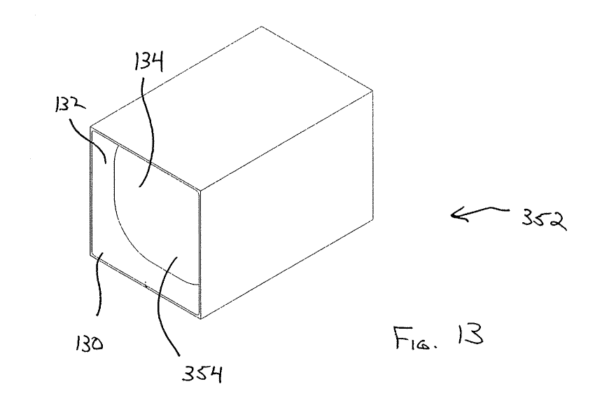

In an alternative embodiment, ultrasonic energy can be used to promote removal of the cookie dough units 208 from each formation portion 105. When ultrasonic energy is utilized, a forming grid 350 can be used with dough retention member 304 to form a forming grid assembly 351 as illustrated in FIG. 12. Forming grid 350 can be fabricated so as to be dimensionally similar to forming grid 100. Forming grid 350 can utilize a single ultrasonic transducer or alternatively, a plurality of ganged ultrasonic transducers 352 can be arranged to define the forming grid 350. Referring to FIG. 13, each individual ultrasonic transducer 352 can define its own formation portion 354. Formation portion 354 can be arranged similarly to the previously described formation portion 105 including formation aperture 130, transition portion 132 and intermediate portion 134. Formation portion 354 can include one or more vent apertures 356 for releasing air entrapped as the forming grid 350 is directed through dough sheet 202 and to assist with release of the cookie dough units 208 from the formation portions 354. Ultrasonic energy can be selectively applied to forming grid 350 such as, for example, only at the time of ejecting the cookie dough units 208 or alternatively, the ultrasonic energy can be applied as the forming grid 350 is directed through the flat sheet 202 so as to assist in cutting and preventing sticking of the cookie dough units 208 within each formation portion 354. Through the use of ultrasonic energy, the cookie dough units 208 preferably are released from the formation portions 354 immediately as the forming grid 350 is directed upwards by the biasing members 320a, 320b, thus avoid the necessity of utilizing ejection member 150. In some embodiments, the application of ultrasonic energy can provide for the use of forming grid 350 without retention member 304.

Although various embodiments of the invention have been disclosed here for purposes of illustration, it should be understood that a variety of changes, modifications and substitutions may be incorporated without departing from either the spirit or scope of the invention

What is claimed:

1. A dough forming apparatus for use in forming a dough unit from a dough sheet comprising:
a forming grid having a formation surface, at least one dough forming portion and an opposing access surface, the forming portion defined by a formation aperture on the formation surface, a transition portion and an intermediate portion, wherein the formation aperture has a formation cross-sectional area exceeding an intermediate cross-sectional area of the intermediate portion and wherein the transition portion includes transitional surfaces for transitioning between the formation cross-sectional area and the intermediate cross-sectional area.

2. The dough forming apparatus of claim 1, wherein the formation cross-sectional area defines a non-circular formation cross-sectional area and the intermediate cross-sectional area defines a circular cross-sectional area.

3. The dough forming apparatus of claim 2, wherein the formation cross-sectional area is selected from the group comprising: a square, a rounded rectangle, an oval, a triangle, a polygon and combinations thereof.

4. The dough forming apparatus of claim 1, wherein the transitional surfaces are selected from the group comprising: a tapered surface, a curved surface, an arced surface, an angled surface and combinations thereof.

5. The dough forming apparatus of claim 1, wherein the forming grid comprises one or more ultrasonic transducers, wherein each ultrasonic transducer defines a dough forming portion.

6. The dough forming apparatus of claim 1, wherein the access surface includes an access aperture such that the dough forming portion defines a formation throughbore connecting the formation surface and the access surface.

7. The dough forming apparatus of claim 1, wherein the access surface includes a vent hole operably connected to the dough forming portion.

8. The dough forming apparatus of claim 1, further comprising a dough retention member operably connected to the forming grid, the dough retention member including a top surface, a peripheral retention wall and a bottom surface and a receiving aperture defined between the top surface and the bottom surface, wherein the forming grid is slidingly receivable within the receiving aperture.

9. A method for forming dough units comprising:
stamping a dough sheet with a forming grid having at least one formation portion such that a dough unit is formed within the at least one formation portion, the at least one formation portion defined by a formation aperture, a transition portion and an intermediate portion, wherein the formation aperture has a forming cross-sectional area exceeding an intermediate cross-sectional area of the intermediate portion, the formation cross-sectional area being operably connected to the intermediate cross-sectional area with the tapered transition portion.

10. The method of claim 9, further comprising:
positioning the dough sheet in a packaging tray prior to stamping the dough sheet.

11. The method of claim 9 further comprising:
placing a plurality of edible particulates on a top surface of the dough sheet such that stamping causes the plurality of edible particulates to be concentrated on a top dough unit surface by funneling the plurality of edible particulates through the tapered transition portion.

12. The method of claim 9, further comprising:
ganging a plurality of individual ultrasonic transducers to define the forming grid, wherein each ultrasonic transducer defines an individual formation portion.

13. The method of claim 9, further comprising:
ejecting a dough unit from the at least one formation portion by introducing a plunger through an access aperture on an access surface such that the plunger is insertable through a formation throughbore to push the dough unit out of the formation portion.

14. The method of claim 9, further comprising:
positioning a dough retention member over the dough sheet such that the dough sheet is constrained within the dough retention member as the forming grid stamps the dough sheet.

15. The method of claim 14, wherein stamping the dough sheet comprises advancing the forming grid through a receiving aperture in the dough retention member.

16. The method of claim 9, further comprising:
venting any entrained air within the formation portion through a vent hole in an access surface.

17. The method of claim 9, further comprising:
applying ultrasonic energy to the forming grid as the dough sheet is stamped.

18. A system for forming dough units comprising:
a forming grid having a formation surface and an opposing access surface wherein at least one formation portion is operably interconnected to the formation surface, the formation portion defined by a formation aperture, a transition portion and an intermediate portion, wherein the formation aperture has a formation cross-sectional area exceeding an intermediate cross-sectional area of the intermediate portion and wherein the transition portion includes transitional surfaces from transitioning between the formation cross-sectional area and the intermediate cross-sectional area.

19. The system of claim 18, further comprising:
an ejection assembly introducing at least one plunger into an access aperture on the access surface, the access aperture operably connected to the at least one formation portion for defining a formation throughbore, the at least one plunger adapted to push on a dough unit within the formation throughbore wherein the dough unit is ejected from the formation aperture.

20. The system of claim 18, wherein the forming grid comprises a dough retention member positionable over a dough sheet such that the dough sheet is constrained within the dough retention member as the forming grid stamps the dough sheet.
